(19) United States
(12) Patent Application Publication
(10) Pub. No.: US 2015/0227309 A1
(43) Pub. Date: Aug. 13, 2015

(54) TOUCH SCREEN INTERFACE GESTURE CONTROL

(71) Applicant: GE Intelligent Platforms, Inc., Charlottesville, VA (US)

(72) Inventors: Pavan Kumar Singh Thakur, Hyderabad (IN); Chandrakanth Venkata Alahari, Hyderabad (IN)

(73) Assignee: GE Intelligent Platforms, Inc., Charlottesville, VA (US)

(21) Appl. No.: 14/178,612

(22) Filed: Feb. 12, 2014

(51) Int. Cl. G06F 3/0488

(52) U.S. Cl. CPC G06F 3/04883

(57) ABSTRACT

Provided is a gesturing mechanism configured for facilitating interaction with a computer via a touchscreen device having a device surface. The mechanism includes a controller having a controller surface configured for accepting a touch gesture. The touchscreen device is configured for executing an application including a plurality of user controls for interacting with the application. The controller is configured for applying an accepted touch gesture to one of the plurality of controls.

### TECHNICAL FIELD

The present invention relates generally to computer interfaces. More particularly, the present invention relates to gesture control devices configured for use as a computer interface to a touch screen device.

### BACKGROUND OF THE INVENTION

Advancements in technology have enabled the integration of technologies, particularly computers, into the everyday human experience. Other advancements correspondingly enhance the ways operators use and control, or interact with, computers.

Computer keyboards offered significant advantages over earlier keypunch machines for enabling humans to control and interact with computers. Keyboard functionality was later aided by advent of the computer mouse. This combined functionality enabled the creation of more visually based interface tools, such as the graphical user interface (GUI).

At the same time, extraordinary developments in computer graphics and monitor technology fostered a merger between humans and computers through a seamless GUI experience. More sophisticated monitor and display technologies (i.e., control of a computer via the single touch of a screen), for example, made the use of computers in homes, in vehicles, and educational settings, for medical purposes, etc., much more practical.

By way of example, touchscreen technology, introduced as a mere concept in the 1970s, is perhaps one of the most significant tools facilitating these more practical applications and uses of computers. Surface computing, a specialized adaptation of the GUI, takes this concept one step further. Given the prevalence and importance of the aforementioned advancements in computer interface technology, ergonomics aspects of these advancements have become equally important.

Consider the ergonomic challenges associated with high form-factor touchscreen devices. Although touchscreen devices offer many advantages, users are required to touch particular points on the device to perform a specific computer interaction, or make a specific gesture. More specifically, in surface computing, the user must touch a specific button or location, within a surface application, displayed on a device (e.g., a monitor). The user's touch is required to perform a specific gesture, such as a single tap, a double tap, a sliding motion, etc., at the button or location, to interact with the surface application.

In the case of high form factor touchscreen devices (e.g., monitors), the user may be required to extend an arm, or hand, across the device to touch the particular button or location. This touch is required to perform the specific gesture. Given the size of the device, and/or the circumstances of use, such an arm or hand extension to reach geographically dispersed buttons or locations, can represent more than a mere inconvenience. That is, the requirement that the user touch the specific button or location on the touch screen device to perform the required gesture can be problematic.

### SUMMARY OF THE EMBODIMENTS

Given the aforementioned deficiencies, a need exists for methods and systems that enable a user to interact with a touchscreen high form factor device without being required to touch multiple locations on the device. More specifically, a need exists for a single control mechanism that can accept user interactions and redirect those interactions to one or more controls to control a computer.

Under certain circumstances, an embodiment of the present invention includes a gesturing apparatus configured for facilitating interaction with a computer via a touchscreen device having a device surface. The apparatus includes a controller having a controller surface configured for accepting a touch gesture. The touchscreen device is configured for executing an application including a plurality of user controls, or human machine interface controls (HMICs), for interacting with the application. The controller is configured for applying an accepted touch gesture to one of the plurality of controls.

Embodiments of the present invention provide a single control mechanism configured for capturing and interpreting user gestures objects. The gestures are redirected for application to a selected HMIC within a surface application displayed on a touchscreen device. This redirection and application eliminates the need for the user to actually touch the selected HMIC. Aspects of the embodiments are particularly applicable to, though not limited, high form factor touchscreen devices, such as monitors having a screen size greater than 18 inches. Monitors, and other devices, having screen sizes less than or equal to 18 inches are within the spirit and scope of the present invention.

Further features and advantages, as well as the structure and operation of various embodiments, are described in detail below with reference to the accompanying drawings. The invention is not limited to the specific embodiments described herein. The embodiments are presented for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an illustration of a screenshot of human machine interface controls required to interact with a surface application configured for display on a conventional touch screen monitor.

FIG. 2 is an illustration of a conventional surface computing gesturing example.

FIG. 3 is an illustration of an exemplary screenshot of a touchscreen monitor and configure in accordance with an embodiment of the present invention.

FIG. 4A is an illustration of a surface computing gesturing example in accordance with a first embodiment of the present invention.

FIG. 4B is an illustration of a surface computing gesturing example in accordance with a second embodiment of the present invention.

FIG. 5 is a flowchart of an exemplary method of practicing an embodiment of the present invention.

### DETAILED DESCRIPTION OF THE EMBODIMENTS

While illustrative embodiments are described herein with illustrative embodiments for particular implementations, it should be understood that the invention is not limited thereto. Those skilled in the art with access to the teachings provided herein will recognize additional modifications, applications, and embodiments within the scope thereof, and additional fields in which the lighting systems described herein would be of significant utility.

The following detailed description is merely exemplary in nature and is not intended to limit the applications and uses disclosed herein. Further, there is no intention to be bound by any theory presented in the preceding background or summary or the following detailed description.

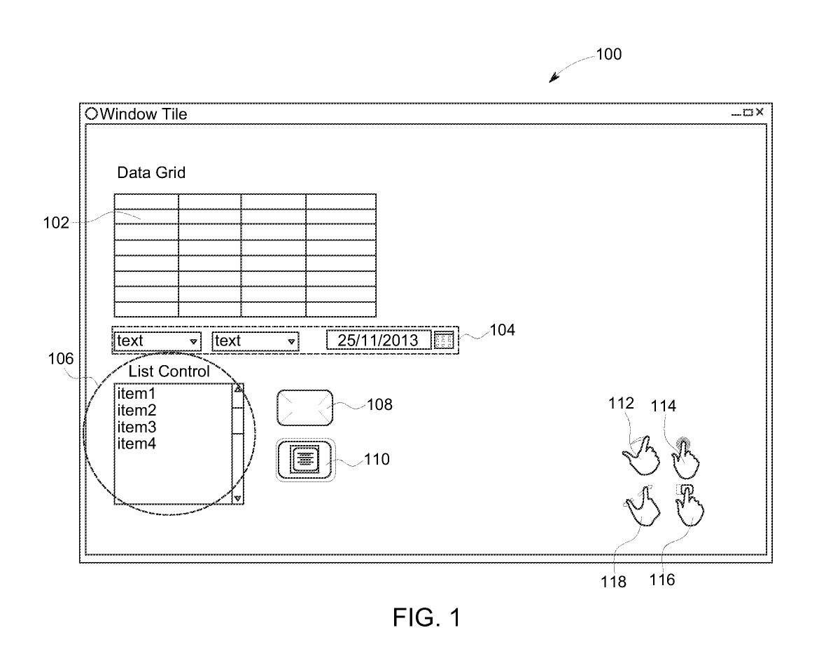

FIG. 1 is an illustration of a screenshot 100 of HMICs required to interact with a surface application displayed on a conventional touch screen device, such as a computer monitor. As noted above, when using conventional touchscreen computing devices, users interact with controls in related surface applications by using touch gestures to control the application. That is, the user is required to physically touch the control wherever it is displayed, for example, when the control is displayed on a computer monitor.

In FIG. 1, for example, the screenshot 100 provides an illustration of the different types of controls, or data, in surface applications that are controllable via touch gestures. In the screenshot 100, a touchscreen device includes a plurality of specific HMICs that facilitate user interaction. These controls can represent text or numerical data within a data grid 102, textual or tabular information 104, control items or objects 106, and button icon controls 108 and 110.

For example, a user can select and activate one of the HMICs 102-110 by touching the control with a digit, such as a finger, and performing a gesture. Exemplary gestures can include movements such as a swipe 112, a single tap 114, a double tap 116, or a pinch/expand gesture 118, when the associated screen control is touched. The gesture cannot be performed if the user does not touch the screen 100.

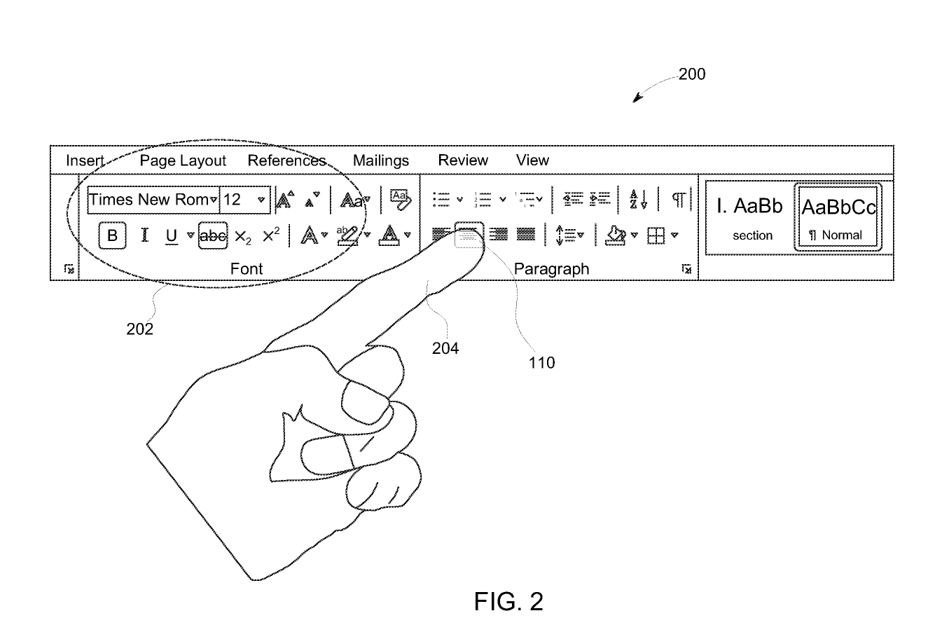

FIG. 2 is an illustration of a conventional touchscreen shot 200 of a user operating a particular one of the selected HMICs 102-110, depicted in FIG. 1. In FIG. 2, the user interacts with a specific surface application, such as a word processing application (WPA), excel spreadsheet, user application, game, or other software program. Each surface application has its own unique controls, such as the controls 202. In the exemplary screenshot 200, the user must apply a single tap gesture 114 to select the HMIC 110 using a digit, such as a finger 204, to perform an underlying activity. In the HMIC 110, the underlying functionality is a “center text” command within the WPA.

In the example of FIG. 2, the user's finger 204 must actually touch the HMIC 110 to interact and perform the underlying operation within the WPA. When using touchscreen mobile devices, or high form factor devices such as a large touchscreen monitor (e.g., >18 in. screen size), additional time, attention, and patience may be required of the user to lean forward or stretch to touch the correct location/control on the device.

Assuming, by way of example, the touchscreen device depicted in FIG. 2 has a 23 in. touchscreen surface size (e.g., ˜20×11 inches). In this example, the user has a total area of approximately 220 square inches (in²) in which to locate and interact with a selected HMIC. In some environments, the time required for the user to focus on a large 220 in.² screen area to apply a gesture could diminish valuable user time and focus that could be applied to more critical activities.

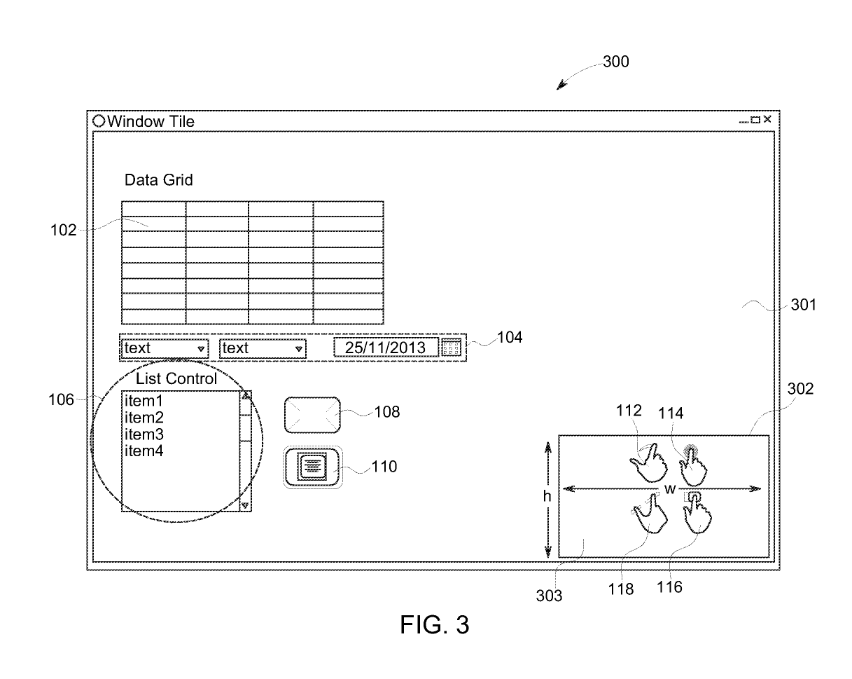

FIG. 3 is an illustration of an exemplary screenshot 300 of a touchscreen monitor configured in accordance with an embodiment of the present invention. The illustrious embodiment depicted in FIG. 3 provides a single gesture control device 302, having a height (h) and a width (w), similar to a laptop touchpad. By way of example, and not limitation, the control device 302 could be located in a corner area of a larger touchscreen monitor 301, as depicted in FIG. 3. However, the control device 302 could be located in other positions within the touch surface area of the monitor. Such alternative areas would be within the spirit and scope of the present invention.

Additionally, the gesture control device 302 has a small touch surface area (e.g. <about 20 in²), substantially smaller than the touchscreen surface. The single smaller surface area of the gesture control device 302 enables a user to interact with a surface application by performing the specific gesture within the single smaller surface area. This eliminates the need for the user to touch an associated control/button within the larger touch surface area displaying the surface application.

Any gesture (e.g., 112-118) performed on the screen 300, to select between the plurality of HMICs 102-110, can be performed within the gesture control device 302 when the user touches a much smaller surface location. By performing the required gesture and control selection within the gesture control device 302, the user avoids the need to touch the actual HMIC 102-110 on the screen 301, to select the underlying functionality represented by thereby. The user is required to focus on the gesture control device 302, which consumes only a small section of the screen 301.

In the illustrious embodiment of FIG. 3, an application screen object is provided by a surface software development kit (SDK) framework that includes various application programming interfaces (APIs). One API provides the handle of a currently selected HMIC. Another API enables the user to actually select the control via a gesture. In the embodiments, the gesture control device 302 knows the gestures that are applicable to a specific HMIC, such as one of the HMICs 102-110.

User preferred gestures (e.g., 112-118) are input to the gesture control device 302 for execution in tandem with a specific user selected control (e.g., the HMIC 110 discussed above). After input of the gestures to the gesture control device 302, the API validates the applicability of each gesture to the user-selected HMIC. During operation, the user's preferred gesture is applied to the user-selected HMIC. However, this application only occurs if the gesture is allowed/supported within the API that provides the handle of the user-selected HMIC.

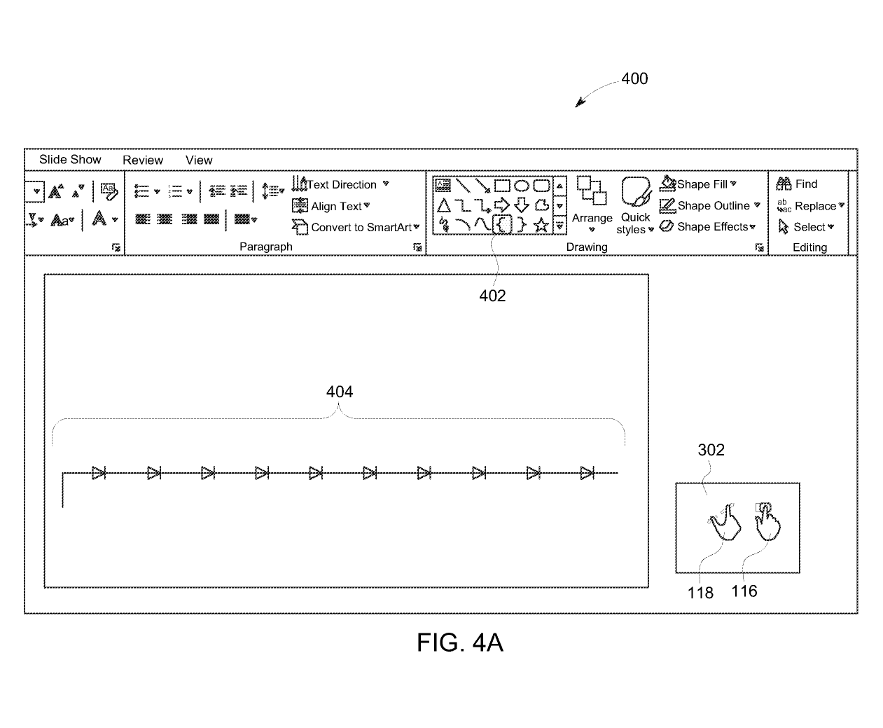

The gesture control device 302 is configured to capture the user's touch gestures that are to be applied, for example, to one of the plurality of HMICs 102-110. In the embodiment, the captured gesture, or user interaction, is redirected and applied to the HMIC in focus (i.e., selected) on the larger monitor 301. Embodiments of the present invention provide an ability for a user to interact with HMICs in the underlying surface application without actually touching the controls. The user only touches the smaller surface area 303 within the gesture control device 302. FIG. 4A is an illustration of a user gesturing only within the gesture control device 302 in accordance with the embodiments.

More specifically, FIG. 4A is an illustration of a surface computing gesturing example 400 in accordance with the embodiments. By way of example, FIG. 4A depicts a HMIC button 402 active and in focus within a touchscreen device 403. The HMIC 402 selects a bracket pattern 404.

In FIG. 4A, the gesture control device 302 will recognize all plausible user gestures (112-118)—gestures capable of facilitating user interaction with the bracket pattern 404. In the surface computing gesturing example 400, plausible user gestures can include the pinch/expand gesture 118 and the double tap gesture 116.

That is, the selection of the bracket pattern 404 by applying the pinch/expand gesture 118 and a double tap 116 to the small touch surface 303. The user is not required to touch the HMIC 402. The user does not need to go to the pattern 404 and apply either of the gestures 118 or 116 to the pattern 404 itself. The user need only apply the gestures to the single and much smaller screen area 303. The user gestures applied to the screen area 303 are interpreted, redirected, and applied to the pattern 404.

The gesture control device 302 includes the information of all the gestures that are applicable to the HMIC 402, for e.g., single tap 114, double-tap 116, expand/pinch 118 gestures. In the embodiments, the user can apply the gestures to the gesture control device 302 rather than applying them on the HMIC 402 itself. Similarly, if it was a list control, the gesture control device 302 will provides gestures such as a vertical swipe, a tap, etc.

In another embodiment of the present invention, the gesture control device 302 is be positioned within a separate housing, external to touchscreen devices, such as the touchscreen device 403. In FIG. 4B, for example, the gesture control device 302 is positioned within a completely separate device 450, external to the touchscreen device 403. The separate housing 450 can be standalone. Alternatively, the housing 450 can represent another electronic device entirely, such as another computer, a smart phone device, a tablet, or similar.

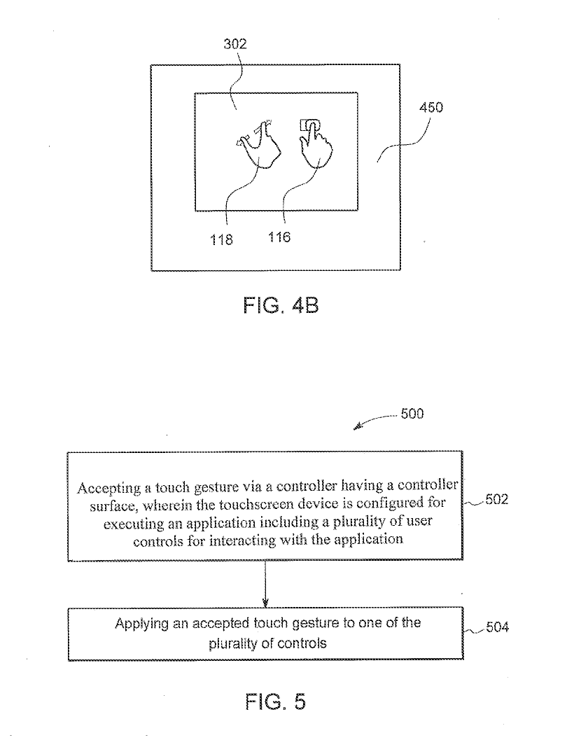

FIG. 5 is a flowchart of an exemplary method 500 of practicing an embodiment of the present invention. The method 500 provides gesturing in a surface within a computer via a touchscreen device having a device surface. The method 500 includes accepting a touch gesture via a controller having a controller surface in block 502. The touchscreen device is configured for executing an application including a plurality of HMICs for interacting with the application. In block 504, an accepted gesture is applied to one of the plurality of controls.

### CONCLUSION

Those skilled in the art, particularly in light of the foregoing teachings, may make alternative embodiments, examples, and modifications that would still be encompassed by the technology. Further, it should be understood that the terminology used to describe the technology is intended to be in the nature of words of description rather than of limitation.

Those skilled in the art will also appreciate that various adaptations and modifications of the preferred and alternative embodiments described above can be configured without departing from the scope and spirit of the technology. Therefore, it is to be understood that, within the scope of the appended claims, the invention may be practiced other than as specifically described herein.

What we claim is:

1. A gesturing apparatus configured for facilitating interaction with a computer via a touchscreen device having a device surface, comprising:
a controller having a controller surface configured for accepting a touch gesture;
wherein the touchscreen device is configured for executing an application including a plurality of user controls for interacting with the application;
wherein the controller is configured for applying an accepted touch gesture to one of the plurality of controls.

2. The gesturing apparatus of claim 1, wherein the accepting includes receiving and correlating a gesture to a user control;
wherein the user control is a human machine interface control (HMIC).

3. The gesturing apparatus of claim 2, wherein the correlating includes determining whether an accepted touch gesture is compatible with a selected HMIC.

4. The gesturing apparatus of claim 1, wherein the application executes within a surface computing environment.

5. The gesturing apparatus of claim 4, wherein the applying includes redirecting the accepted gesture to the to the selected user control.

6. The gesturing apparatus of claim 1, wherein the controller surface is integrated into the device surface.

7. The gesturing apparatus of claim 1, wherein the device is a display monitor.

8. The gesturing apparatus of claim 1, wherein the controller surface is substantially smaller than the device surface.

9. The gesturing apparatus of claim 1, wherein the controller is positioned within at least one from the group including a region of the device surface and within a device external to the touchscreen device.

10. A method for providing gesturing in a surface within a computer via a touchscreen device having a device surface, the method comprising:
accepting a touch gesture via a controller having a controller surface;
wherein the touchscreen device is configured for executing an application including a plurality of user controls for interacting with the application; and
applying an accepted touch gesture to one of the plurality of controls.

11. The method of claim 10, wherein the accepting includes receiving a gesture and correlating the received gesture to a user control;
wherein the user control is a human machine interface control (HMIC).

12. The method of claim 11, wherein the correlating includes determining whether an accepted touch gesture is compatible with a selected HMIC.

13. The method of claim 11, wherein the application executes within a surface computing environment.

14. The method of claim 11, wherein the applying includes redirecting the accepted gesture to the selected HMIC.

15. A computer readable media storing instructions wherein said instructions when executed are adapted to execute processes within a computer system, with a method comprising:
accepting a touch gesture via a controller having a controller surface;
wherein the touchscreen device is configured for executing an application including a plurality of user controls for interacting with the application; and
applying an accepted touch gesture to one of the plurality of controls.

16. The computer readable media of claim 15, wherein the accepting includes receiving a gesture and correlating the received gesture to a user control;
wherein the user control is a human machine interface control (HMIC).

17. The computer readable media of claim 16, wherein the correlating includes determining whether an accepted touch gesture is compatible with a selected HMIC.

18. The computer readable media of claim 17, wherein the application executes within a surface computing environment.

19. The computer readable media of claim 17, wherein the applying includes redirecting the accepted gesture to the selected HMIC.

20. The computer readable media of claim 15, wherein the accepting includes receiving a gesture and correlating the received gesture to a HMIC.
